(19) United States
(12) Patent Application Publication
(10) Pub. No.: US 2012/0056498 A1
(43) Pub. Date: Mar. 8, 2012

(54) RFID TAG WITH ENERGY COLLECTING FUNCTION

(76) Inventor: LIPING ZHU, SAN JOSE, CA (US)

(21) Appl. No.: 13/225,516

(22) Filed: Sep. 5, 2011

Related U.S. Application Data
(60) Provisional application No. 61/380,318, filed on Sep. 6, 2010.

(30) Foreign Application Priority Data
Nov. 29, 2010 (CN) 201010571936.1

(51) Int. Cl. H02J 4/00

(52) U.S. Cl. 307/154

(57) ABSTRACT

The present invention provides an RFID tag with energy collecting function, comprising a shell, and an RFID circuit is arranged in the shell. The RFID tag also comprises an energy converter and an energy-storage unit, wherein the energy converter is used for converting external energy of the RFID tag to electrical energy, the energy-storage unit is arranged in the shell for storing electrical energy generated by the energy converter, so as to provide electricity for the RFID circuit. In the RFID tag in the present invention, by arranging the energy converter to convert the energy, the RFID tag has an energy collecting function; therefore, batteries are not needed to be replaced continuously, so as to be convenient for users.

### CROSS-REFERENCE TO RELATED APPLICATIONS

This application claims priority of provisional application No. 61/380,318, filed on Sep. 6, 2010, and Chinese Patent Application No. 201010571936.1 filed on Nov. 29, 2010, which are hereby incorporated by reference in their entirety.

### FIELD OF THE TECHNOLOGY

The present invention relates to an RFID (radio frequency identification) tag with energy collecting function, belonging to the power supply technical field of the RFID tag.

### BACKGROUND

There are mainly the following three kinds of RFID tags in the prior art:

1. A passive RFID tag, which does not use a battery and reflects signals from a reader to perform communication, the reading distance is 10 feet usually; and the reading distance can be expanded by some creative antenna designers and tag manufacturers by using a special shell.

2. A semi-passive RFID tag, which adopts the same reading mechanism as the passive RFID tag and uses a battery to expand the reading distance.

3. An active RFID tag, which has its own energy source, can send radio-frequency signals actively and does not need to reflect signals from the reader, therefore, longer reading distance can be realized.

The technical problems in the prior art are as follows: the existing semi-passive RFID tag and the active RFID tag both need the energy-storage units such as the battery, although the energy consumption of the battery is low, replacement of the battery is needed regularly, this brings great trouble to users. The existing research on the RFID tag is only limited to improving the antenna technology or material to improve the utilization efficiency of the battery, but the trouble of battery replacement can not be solved. Furthermore, although an external solar panel and other methods are adopted to supply power for the reader in the prior art so that the RFID reader can be installed in the open air without erecting power transmission lines, the battery replacement of the RFID tag is still needed.

### SUMMARY

The present invention provides an RFID tag with energy collecting function, which does not need to replace the battery.

The present invention provides an RFID tag with energy collecting function, comprising a shell in which an RFID circuit is arranged. The RFID tag also comprises an energy converter and an energy-storage unit, wherein the energy converter is used for converting external energy outside of the RFID tag to electrical energy, the energy-storage unit is arranged in the shell for storing electrical energy generated by the energy converter, so as to provide electricity for the RFID circuit.

In the RFID tag of the present invention, by arranging the energy converter to convert the energy, the RFID tag has an energy collecting function; therefore, batteries are not needed to be replaced continuously, so as to be convenient for users.

### BRIEF DESCRIPTION OF THE DRAWINGS

In order to clearly describe the embodiments of the invention or the technical scheme in the prior art, a brief introduction on the drawings needed in the embodiments of the invention or the technical scheme in the prior art is given, obviously, the drawings described are some embodiments of the invention, a person skilled in the field can obtain other drawings according to the following drawings without conducting creative work.

FIG. 1 is the structural schematic view of embodiment I of the RFID tag with energy collecting function according to the present invention;

FIG. 2 is the structural schematic view of embodiment II of the RFID tag with energy collecting function according to the present invention;

FIG. 3 is the structural schematic view of embodiment III of the RFID tag with energy collecting function according to the present invention.

### DETAILED DESCRIPTION

In order to make the objects, technical solutions and merits of the present invention clearer, a further clear and complete description of embodiments of the present invention is given by reference to accompanying drawings in the embodiments of the present invention. Obviously, the described embodiments are part of embodiments of the present invention, but not all embodiments. Based on the embodiments of the present invention, other embodiments that can be obtained by a person skilled in the field without conducting creative work are also in the protective range of the present invention.

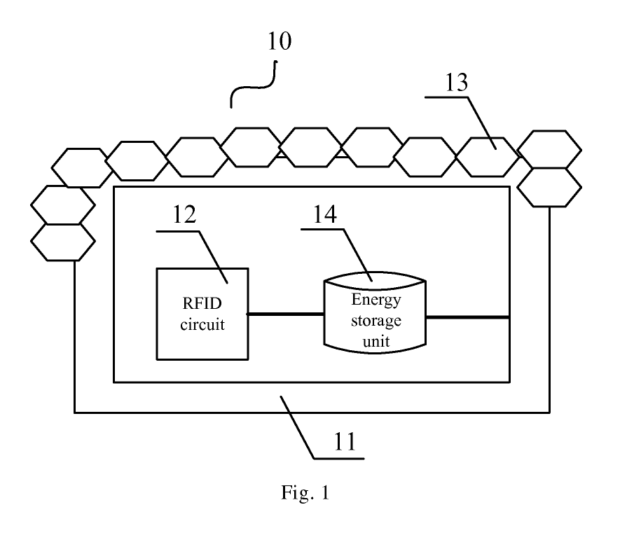

FIG. 1 is the structural schematic view of embodiment I of the RFID tag with energy collecting function according to the present invention, as shown in FIG. 1, an RFID tag 10 comprises a shell 11 in which an RFID circuit 12 is arranged; the RFID tag 10 also comprises an energy converter 13 and an energy-storage unit 14, wherein the energy converter 13 is used for converting external energy outside of the RFID tag 10 to electrical energy, the energy-storage unit 14 is arranged in the shell for storing electrical energy generated by the energy converter 13, so as to provide electricity for the RFID circuit 12.

Particularly, in the embodiment, the energy converter 13 is arranged on the surface of the shell 11 and is connected with the energy-storage unit 14. The cross-sectional area of the shell 11 can be changed according to different designs and applications, for instance, the cross-sectional area of the shell 11 can be 3 cm×8 cm or larger, and the top area of the shell 11 is 24 cm². The efficiency and power output of the energy converter 13 are different along with the change of design, structure, material, operation temperature, input power and matching impedance, so as to generate required voltage. The energy converter 13 has the following types according to needs of energy conversion:

The energy converter 13 can be a photoelectric converter, such as a solar panel, for converting solar energy into electrical energy.

The energy converter 13 can be a thermoelectric converter which comprises two metal plates for collecting temperature difference, for instance, one of the metal plates is arranged in a hot area, the other metal plate is arranged in a cold area. The thermoelectric converter is used for converting temperature difference between two metal plates into electrical energy. Particularly, temperature difference between two metal plates can cause load particles in a conducting material to disperse, so as to generate voltage difference between the hot area and the cold area for being used as electrical energy, for instance, one metal plate can be arranged outside a container or a transportation vehicle to be in the cold area, and the other metal plate can be arranged inside a shielded object, an air conditioner or the transportation vehicle to be in the hot area.

The energy converter 13 can be a piezoelectric converter; the RFID tag is connected to a pressurized device, the energy converter is the piezoelectric converter and is used for converting pressure generated by the pressurized device into electrical energy. Particularly, the pressurized device can be a bottom spring of a transportation vehicle, and the piezoelectric converter is used for converting pressure generated by compressing the bottom spring by weight of the transportation vehicle into electrical energy, wherein the pressure can cause deformation of a piezoelectric capacitor in the piezoelectric converter to generate voltage as electrical energy.

The energy converter 13 can be an electromagnetic converter, a coil and other vibratory objects are used for cutting magnetic lines of force to cause change of magnetic flux to generate alternating current voltage through the coil as electrical energy. The electromagnetic converter can be an antenna which can be manufactured by a simple wire segment. When the antenna receives signals, the electromagnetic energy is converted into electrical energy, and when the antenna sends signals, the electrical energy is converted into the electromagnetic energy. In warehouses or parking lots, the antenna can be used as an electromagnetic sensor to collect radio frequency noise in a proper frequency range to convert it into electrical energy.

The energy converter 13 can be a static electricity converter which comprises a variode and is provided with a fixed electrode and a moveable electrode, wherein the fixed electrode is arranged on the shell 11, the moveable electrode is arranged on a moving object such as shoes worn by people who walk, the voltage of the variode is changed owning to the movement of the moveable object, so as to convert mechanical energy of the moving object into electrical energy.

The energy-storage unit 14 can be a film battery for storing electrical energy converted by the energy converter 13, and the electrical energy is used for providing electricity for the RFID circuit 12. When the RFID tag 10 of the present invention is a semi-passive RFID tag, the electrical energy can be utilized to expand the reading distance; when the RFID tag 10 of the present invention is an active RFID tag, the electrical energy can be utilized to send radio-frequency signals actively to be communicated with the RFID reader (not shown in drawings). The typical transmitting power of the active RFID tag is at milliwatt level, and the photoelectric converter or the piezoelectric converter can be used as the energy converter 13 to supply power.

In the RFID tag of the embodiment, energy conversion can be realized by arranging the energy converter, so as to have an energy collecting function; therefore, batteries are not needed to be replaced continuously, so as to be convenient for users. The RFID tag can be widely applied to specific applications such as automobiles, engines and the like.

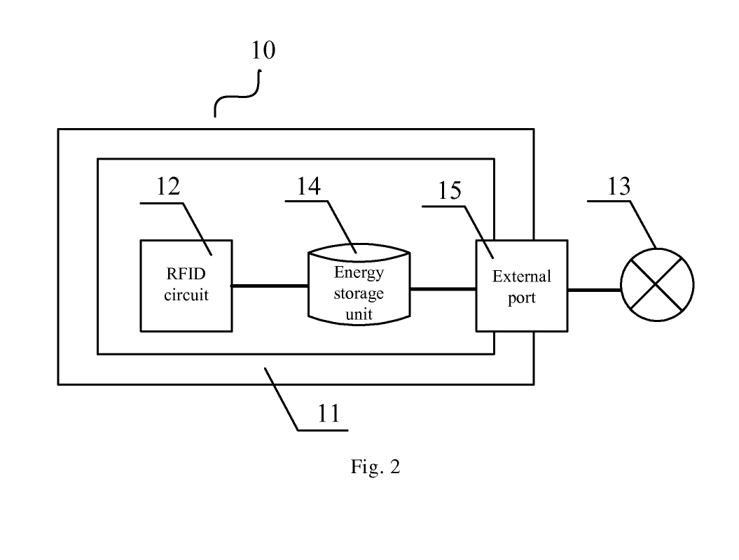

FIG. 2 is the structural schematic view of embodiment II of the RFID tag with energy collecting function according to the present invention, as shown in FIG. 2, the structure of the RFID tag 10 of embodiment II is much the same as that of embodiment I, the RFID tag 10 comprises a shell 11, an RFID circuit 12, an energy converter 13 and an energy-storage unit 14, and the difference is that in embodiment II, the energy converter 13 isn't connected with the energy-storage unit 14 directly, an external port 15 which is connected with the energy-storage unit 14 is arranged on the shell 11, the energy converter 13 is arranged outside the shell 11 and is connected with the energy-storage unit 14 by the external port 15.

Wind energy is an energy source with large changing rate, a wind turbine generator and other wind power converters hardly have small enough size to be arranged on the RFID tag. In this embodiment, the energy converter 13 is arranged outside the shell 11, therefore, the limit to volume of the energy converter 13 is eliminated, so that in addition to the photoelectric converter, the thermoelectric converter or the piezoelectric converter, a wind power converter with large volume also can be used as the energy converter 13 for converting wind energy into electrical energy. For instance, the wind power converter can be the wind turbine generator.

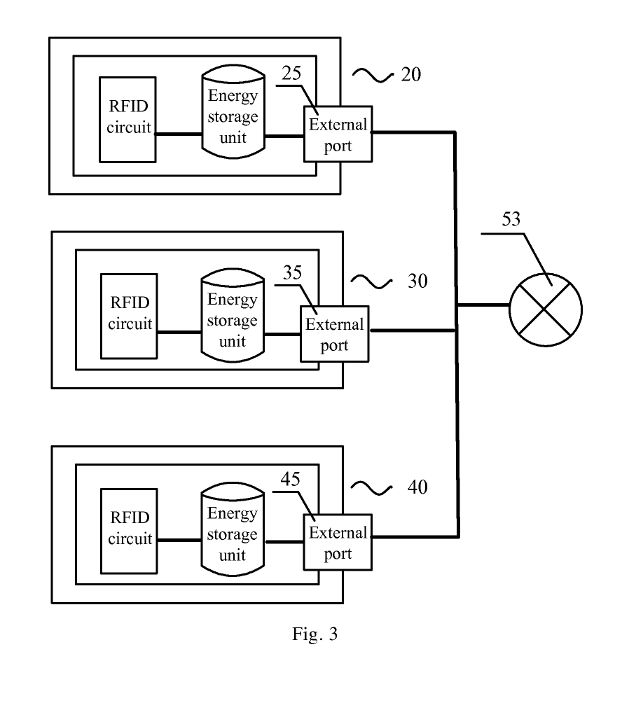

FIG. 3 is the structural schematic view of embodiment III of the RFID tag with an energy collecting function according to the present invention. As shown in FIG. 3, the structure of the RFID tag 10 of embodiment III is much the same as that of embodiment II, and the difference is that in embodiment III, the wind power converter used as the energy converter is respectively connected with external ports of a plurality of the RFID tags, for instance, in FIG. 3, a wind power converter 53 is connected with an external port 25 of a first RFID tag 20, an external port 35 of a second RFID tag 30 and an external port 45 of a third RFID tag 40, so that a plurality of the RFID tags use one wind power converter commonly.

As a wind power converter such as a wind turbine generator has large volume, more electrical energy is converted from the wind energy, a single RFID tag can not fully utilize so much electrical energy. Therefore, in embodiment III, a plurality of the RFID tags use one wind power converter commonly, so as to improve the utilization rate of the electrical energy; furthermore, the electrical energy can be used for providing electricity for the RFID reader in the field work.

Finally, it is to be understood that the above embodiments merely explain the technical scheme of the invention but are not restrictive. Although the invention is explained in detail referring to the above embodiments, persons skilled in the art understand that revisions to the technical schemes of the embodiments or equivalents to partial technical characteristics can be still performed, but the gist of the technical schemes of the revisions or the equivalents are within the true spirit and scope of the technical schemes of all embodiments of the invention.

What is claimed is:

1. An RFID tag with energy collecting function, comprising a shell and an RFID circuit arranged in the shell, wherein the RFID tag further comprises an energy converter and an energy-storage unit, the energy converter is used for converting external energy to electrical energy, the energy-storage unit is arranged in the shell for storing the electrical energy generated by the energy converter, so as to provide electricity for the RFID circuit.

2. The RFID tag with energy collecting function according to claim 1, wherein the energy converter is arranged on the surface of the shell and is connected with the energy-storage unit.

3. The RFID tag with energy collecting function according to claim 1, wherein an external port is arranged on the shell and is connected with the energy-storage unit; the energy converter is arranged outside the shell and is connected with the energy-storage unit through the external port.

4. The RFID tag with energy collecting function according to claim 1, wherein the energy converter is a photoelectric converter and is used for converting solar energy into electrical energy.

5. The RFID tag with energy collecting function according to claim 2, wherein the energy converter is a photoelectric converter and is used for converting solar energy into electrical energy.

6. The RFID tag with energy collecting function according to claim 3, wherein the energy converter is a photoelectric converter and is used for converting solar energy into electrical energy.

7. The RFID tag with energy collecting function according to claim 1, wherein the energy converter is a thermoelectric converter which comprises two metal plates for collecting temperature difference, and the thermoelectric converter is used for converting temperature difference between two metal plates into electrical energy.

8. The RFID tag with energy collecting function according to claim 2, wherein the energy converter is a thermoelectric converter which comprises two metal plates for collecting temperature difference, and the thermoelectric converter is used for converting temperature difference between two metal plates into electrical energy.

9. The RFID tag with energy collecting function according to claim 3, wherein the energy converter is a thermoelectric converter which comprises two metal plates for collecting temperature difference, and the thermoelectric converter is used for converting temperature difference between two metal plates into electrical energy.

10. The RFID tag with energy collecting function according to claim 1, wherein the RFID tag is connected to a pressurized device, the energy converter is a piezoelectric converter and is used for converting pressure generated by the pressurized device into electrical energy.

11. The RFID tag with energy collecting function according to claim 2, wherein the RFID tag is connected to a pressurized device, the energy converter is a piezoelectric converter and is used for converting pressure generated by the pressurized device into electrical energy.

12. The RFID tag with energy collecting function according to claim 3, wherein the RFID tag is connected to a pressurized device, the energy converter is a piezoelectric converter and is used for converting pressure generated by the pressurized device into electrical energy.

13. The RFID tag with energy collecting function according to claim 1, wherein the energy converter is an electromagnetic converter for generating electrical energy by cutting magnetic lines by a vibratory object.

14. The RFID tag with energy collecting function according to claim 2, wherein the energy converter is an electromagnetic converter for generating electrical energy by cutting magnetic lines by a vibratory object.

15. The RFID tag with energy collecting function according to claim 3, wherein the energy converter is an electromagnetic converter for generating electrical energy by cutting magnetic lines by a vibratory object.

16. The RFID tag with energy collecting function according to claim 1, wherein the energy converter is an static electricity converter which comprises a variode and is provided with a fixed electrode and a moveable electrode, the fixed electrode is arranged on the shell, the moveable electrode is arranged on a moving object, the voltage of the variode is changed owning to movement of the moving object, so as to convert mechanical energy into electrical energy.

17. The RFID tag with energy collecting function according to claim 2, wherein the energy converter is an static electricity converter which comprises a variode and is provided with a fixed electrode and a moveable electrode, the fixed electrode is arranged on the shell, the moveable electrode is arranged on a moving object, the voltage of the variode is changed owning to movement of the moving object, so as to convert mechanical energy into electrical energy.

18. The RFID tag with energy collecting function according to claim 3, wherein the energy converter is an static electricity converter which comprises a variode and is provided with a fixed electrode and a moveable electrode, the fixed electrode is arranged on the shell, the moveable electrode is arranged on a moving object, the voltage of the variode is changed owning to movement of the moving object, so as to convert mechanical energy into electrical energy.

19. The RFID tag with energy collecting function according to claim 3, wherein the energy converter is a wind power converter for converting wind energy into electrical energy.

20. The RFID tag with energy collecting function according to claim 19, wherein the wind power converter is respectively connected with external ports of a plurality of the RFID tags.
